(19) United States
(12) Patent Application Publication
(10) Pub. No.: US 2026/0036109 A1
(43) Pub. Date: Feb. 5, 2026

(54) A HYDRO-DYNAMIC ELECTRIC MACHINE HAVING TANDEM WATER TOWERS FOR USE WITH A PLURALITY OF SHUTTLES TO GENERATE ELECTRICITY

(71) Applicant: Gravitas E2P Inc., Rancho Santa Fe, CA (US)

(72) Inventor: Neil K. NYDEGGER, Rancho Santa Fe, CA (US)

(21) Appl. No.: 18/793,777

(22) Filed: Aug. 3, 2024

(51) Int. Cl. F03B 11/00; F03B 17/04; H02K 53/00

(52) U.S. Cl. CPC F03B 11/004; F03B 17/04; H02K 53/00; F05B 2220/707; F05B 2230/60

(57) ABSTRACT

A hydro-dynamic electric Machine for generating electricity includes tandem water towers which are aligned parallel with each other. The water towers are vertically oriented and are mounted on top of a transfer tank for controlled water communication therewith. Linear generators are also positioned on top of the transfer tank, with each linear generator adjacent and parallel with a respective water tower. In accordance with the present invention, a control unit is provided to maintain predetermined separation distances between a plurality of sequential shuttles as they traverse through the machine on respective closed loop circuits for their engagement with different linear generators to sequentially generate electricity.

### FIELD OF THE INVENTION

The present invention pertains generally to machines which generate electricity using motive forces from the earth's gravitational field, i.e. gravity and buoyancy. More specifically, the present invention pertains to machines which generate electricity using two separate, but simultaneously operated electricity generators. The present invention is particularly, but not exclusively directed to machines for generating electricity which generate a sufficient electrical output to provide a portion of the output as feedback for operating the machine.

### BACKGROUND OF THE INVENTION

Although the forces of gravity and buoyancy are well known, and have been effectively used separately for many different purposes, attempts to use these forces together to generate electricity have heretofore either been overlooked, frustrated or summarily dismissed. These evaluations have, however, been essentially based on only static comparisons of input and output work requirements. A result here has been that dynamic considerations of operational factors have been essentially overlooked.

The dynamic effect of using buoyancy and gravity as input work forces, and the possibility of their use being sufficient to provide an output that includes feedback for operating the machine has not been fully considered. Thus, a combined consideration of power and kinetic energy within a predetermined machine work cycle, has heretofore not been pursued.

Structurally and operationally, a machine which can be designed in accordance with the present invention is described in detail in both U.S. patent application Ser. No. 18/628,709 which is entitled “System for Generating Electricity with Tandem Towers”, and which was filed on Apr. 6, 2024, and U.S. patent application Ser. No. 18/674,839 which is entitled “Methodology for Designing a Tandem Tower Machine for Generating Electricity”, which was filed on May 25, 2024. The present invention however now goes further to provide a methodology which describes how considerations of power and time can be used to optimize the efficiency of an electricity generating machine by employing a plurality of shuttles.

It happens that by starting with a desired output power for the machine, e.g. 100 kW, time considerations are introduced into the design methodology of the present invention. By definition, a watt W has units of work/second. Furthermore, the work/energy relationship, which is mathematically expressed as ƒₛfds=½mv², shows that the kinetic energy of a buoyant shuttle (½ mv²) is a function of both the shuttle's mass, “m”, and its velocity, “v”, which is expressed as a distance/second. With this in mind, the present invention teaches how structural configurations for components of the machine can be constructed, and how the mass and velocity values for a shuttle can be selected for cooperation with each other in a same time frame. More specifically, an objective of the present invention is to construct a hydro-dynamic electric structure for employing buoyant shuttles which have mass and velocity values that will establish an optimal output during each machine work cycle

Operationally, a dynamic evaluation of an electricity generator for the present invention shows that an output power from the electricity generator can be engineered to be greater than its input power requirement during a predetermined machine work cycle. This happens because the total output work is cumulative from second to second during a machine work cycle, while the total input work has a fixed value regardless of work cycle duration. As disclosed in detail below, a machine work cycle of more than two seconds duration will typically generate an output work that exceeds the input work requirement. Consequently, a portion of the output work can be used as feedback to run the machine, while the excess work (i.e. electrical energy) can be sent to the grid for commercial and residential use.

An object of the present invention is to provide a machine which can generate excess electricity for commercial and residential purposes beyond the electricity input requirement to run the machine. Another object of the present invention is to provide a methodology for designing an electricity generating machine that is both scalable and flexible for adaptation to a variety of commercial and residential objectives. Still another object of the present invention is to provide a machine for generating electricity that is easy to use, is simple to manufacture and is comparatively cost effective.

### SUMMARY OF THE INVENTION

A tandem tower machine for generating electricity in accordance with the present invention requires a buoyant shuttle which must travel on a vertically oriented closed-loop pathway during each machine work cycle. The only motive forces acting on the shuttle during its transit of this closed-loop pathway are the forces of gravity and buoyancy from the earth's gravitational field. For disclosure purposes, consider that during a machine work cycle the shuttle will first travel downwardly on an air pathway under the influence of gravity, and then upwardly on a water pathway under the influence of its buoyancy.

In detail, the shuttle's closed-loop pathway can be considered as four different consecutive time sectors which each have different functionalities. First, there is a sector A where the shuttle falls onto the air pathway from an elevated start point and accelerates under the influence of gravity for engagement with a linear generator at a constant velocity. Note, it is in time sector A where all of the machine's electricity output is generated. Then, to begin time sector B, the shuttle disengages from the linear generator and dives into a transfer tank. The shuttle then decelerates in the transfer tank and follows a guideway that directs the submerged shuttle through the transfer tank into a water tower. Time sector C then provides a vertical water pathway for the buoyant shuttle to rise through the water tower and back to its elevated start point for the next machine work cycle. In time sector D the shuttle is received and held as needed for a time controlled drop from the elevated start point for the machine's next duty cycle.

An important aspect of the present invention is that both the distance traveled, and the actual time duration spent by a shuttle in each time sector on the closed-loop pathway will be different. These differences are specifically the result of hydraulic and mechanical actions that are required to guide a shuttle along the pathway.

From a design perspective, the time sector A is of primary importance. As noted above, it is in time sector A that a machine's output is generated. Time sector B, however, must be greater than or equal to time sector A. This is so, because each shuttle must transit and vacate the transfer tank within time sector B before the arrival of a next shuttle in the transfer tank. Time sector C, however, has no direct interaction with the shuttle other than providing a water pathway on which buoyant shuttles return to the elevated start point. Indeed, the duration of time sector C, may extend for a plurality of time sectors A and accommodate a plurality of shuttles. Operational control of the machine is provided in time sector D where a controlled drop time for each shuttle is performed by an activator in accordance with a predetermined machine protocol.

Structurally, the closed-loop pathway requires an upper pivot point and a lower pivot point. The upper pivot point is established near the top of the water tower where the shuttle transitions from the water pathway to the air pathway for its fall and engagement with the linear generator. The lower pivot point, however, is established in the transfer tank where the submerged shuttle decelerates and begins its ascent into and upwardly through the water tower. A guideway is provided for this purpose at the lower pivot point for directing the submerged shuttle through the transfer tank. As noted above, an activator is provided at the upper pivot point to begin a work cycle by dropping successive shuttles in accordance with a control protocol.

### BRIEF DESCRIPTION OF THE DRAWINGS

The novel features of this invention, as well as the invention itself, both as to its structure and its operation, will be best understood from the accompanying description in which similar reference characters refer to similar parts of the invention, and in which:

FIG. 1 is a perspective view of a tandem tower machine for generating electricity;

FIG. 2 is a cross section view of the tandem tower machine as seen along the line 2-2 in FIG. 1;

FIG. 3 is a schematic diagram of one of the electricity generators for a tandem tower machine shown in FIG. 2, which identifies a sequence of time sectors A-D for a machine work cycle, wherein half of a machine's total output is generated by each of two mirror-image electricity generators during a same machine work cycle; and

FIG. 4 is a time-line graph showing the relative durations of the individual time sectors A-D during a machine work cycle.

### DESCRIPTION OF THE PREFERRED EMBODIMENTS

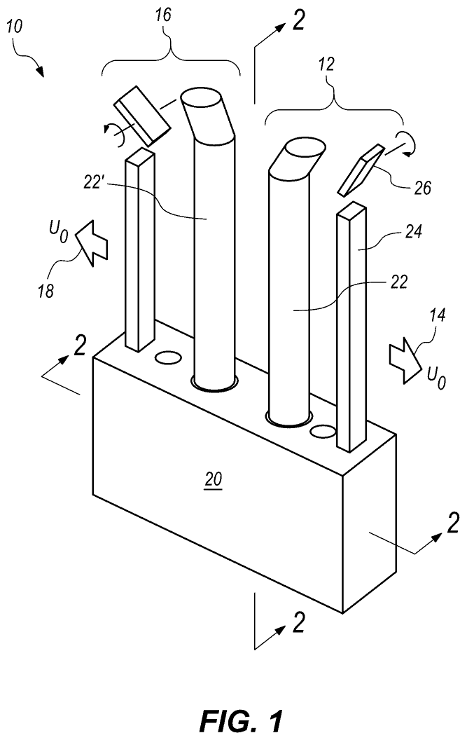

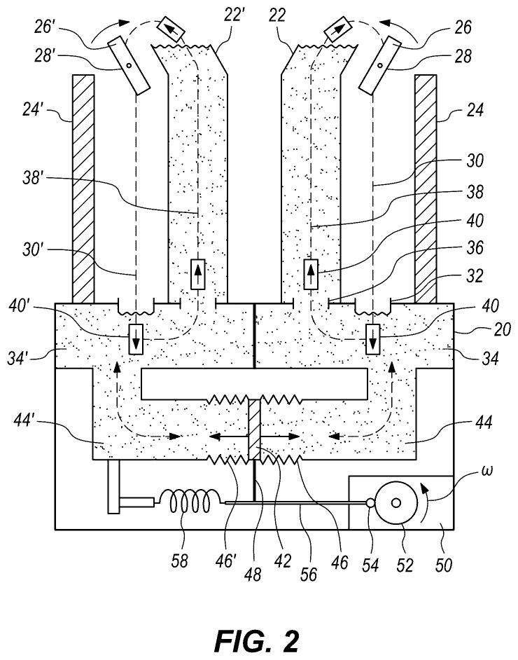

A machine for generating electricity in accordance with the present invention is shown in FIG. 1 and is generally designated 10. As shown, the machine 10 includes a first electricity generator 12 for generating a first electricity output 14 (Uₒ), and a second electricity generator 16 for generating a second electricity output 18 (Uₒ). Both of these electricity generators 12 and 16 are shown mounted vertically, in tandem, on top of a transfer tank 20. Structural details for the electricity generators 12 and 16 are shown in FIG. 2.

Due to the structural similarities of the mirror-image electricity generators 12 and 16, the reference characters (numerals) used to identify comparable components in the respective generators 12/16 will be distinguished by the use of a prime (′) for components of electricity generator 16. For example, the water tower 22 of electricity generator 12 is designated in FIG. 2 as water tower 22, whereas the water tower of electricity generator 16 is designated as water tower 22′.

With reference to FIG. 2, the water tower 22 of first electricity generator 12 is shown vertically oriented parallel to a linear generator 24. Also, a rotatable platform 26 is shown positioned at an elevated start point 28 at the top of water tower 22 and above the linear generator 24. In this combination, the water tower 22 and the linear generator 24 are vertically mounted on the transfer tank 20 to establish an air pathway 30 therebetween. An access valve 32 allows for controlled access onto the air pathway 30 and into a water compartment 34 of the transfer tank 20. A transfer valve 36 then provides controlled access along a water pathway 38 that extends from the water compartment 34 and into the water tower 22. Thus, the air pathway 30 and the water pathway 38 together establish a closed-loop pathway for the electricity generator 12. Similarly, the air pathway 30′ and the water pathway 38′ establish a closed-loop pathway for the second electricity generator 16.

As envisioned for the present invention a plurality of shuttles 40 can transit the closed-loop pathway of the first electricity generator 12. Simultaneously a plurality of shuttles 40′ can likewise transit the closed-loop pathway of the second electricity generator 16. This cooperation between the electricity generators 12 and 16 is established by a common reciprocating piston plate 42 that is located in a water channel 44 where it is connected between bellows 46 and 46′. At this location, the piston plate 42 is positioned to interact with both of the respective water compartments 34 and 34′ of the electricity generators 12 and 16. Also, the piston plate 42 is engaged via a connector 48 with a control unit 50 which reciprocates the piston plate 42 back and forth in the water channel 44.

In detail, the control unit 50 rotates an eccentric cam drive 52 with an angular velocity w which interacts via a roller 54 with a drive bar 56 to linearly reciprocate the drive bar 56. As shown in FIG. 2, a reciprocation of the drive bar 56 also acts to compress and decompress a spring 58. Thus, as the drive bar 56 reciprocates it alternately powers a reciprocating movement of the piston plate 42. The consequence here is that the electricity generators 12 and 16 are alternatingly driven to generate respective electricity outputs 14 and 18 which together provide a total electricity output for the machine 10. As intended for the present invention, the machine 10 is designed to operate continuously, with a plurality of shuttles 40 which are respectively employed in each of the electricity generators 12 and 16.

The design for building a machine 10 specifically requires considerations of the time duration needed for a single shuttle 40 to transit each respective sector on the machine's closed-loop pathway. Sequential time sector durations must then be collectively evaluated to establish a desired machine 10 work cycle.

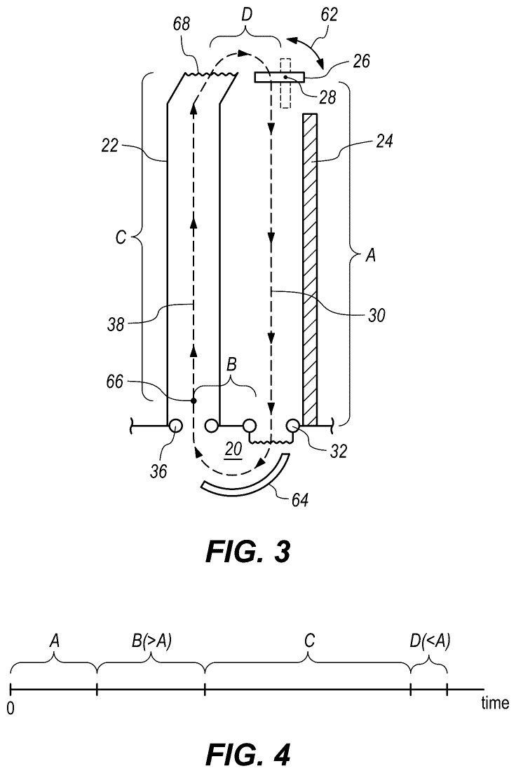

For purposes of this disclosure, FIG. 3 alphabetically identifies the separate time sectors of a machine 10 duty cycle. FIG. 3 also portrays each time sector as a travel distance on the closed-loop pathway during a complete duty cycle of the machine 10, i.e. travel distances along air pathway 30 and water pathway 38. In the context of the present invention, however, a shuttle's time-travel/sector, rather than its travel-distance/sector, is the more productive consideration. Accordingly, to be concise, the time duration for shuttle 40 time travel through a given sector is referred to here simply by the alphabetic identification of the sector, i.e. “A” is used to indicate the time duration for shuttle 40 travel through time sector A.

As shown in FIG. 3, the time sector A begins at the elevated start point 28 adjacent the top of the water tower 22 where the platform 26 receives a shuttle 40 and then rotates in the direction of arrows 62 to drop the shuttle from there onto the air pathway 30. The shuttle 40 while engaged with the linear generator 24 then falls along the air pathway 30 under the influence of gravity to generate a work output, Uₒ. Upon disengagement from the linear generator 24, the shuttle 40 passes through an access valve 32 and enters the transfer tank 20.

Time sector B starts at the access valve 32 and extends through the transfer tank 20. At the beginning of time sector B, the shuttle 40 decelerates in the transfer tank 20 and engages with a guideway 64. The shuttle 40 then continues along the guideway 64 and eventually accelerates upwardly from the guideway 64 under the influence of its buoyancy. The shuttle 40 continues to accelerate upwardly toward a point 66 on the water pathway 38 above the transfer valve 36 where time sector B ends.

At point 66 on water pathway 38, the shuttle 40 may or may not have reached its terminal velocity “vₜ” in water tower 22. Nevertheless, the important consideration here is that the shuttle 40 is at the point 66 on water pathway 38 which above transfer valve 36. Importantly, this allows the transfer valve 36 to be closed. Time sector C extends upwardly through the water tower 22 from point 66 to the upper water level 68 of water tower 22 where the shuttle 40 breaches from the water tower 22. Also, with transfer valve 36 closed, and with access valve 32 simultaneously opened, the transfer tank 20 can be reconfigured to receive the next successive shuttle 40.

Time sector D is preferably shorter in time duration than any of the other time sectors A-C, but it is controllable. Indeed, the sole purpose of time sector D is to drop a shuttle 40 onto air pathway 30 at the proper time to begin time sector A. Succinctly stated, time sector D provides a reset capability for the machine 10.

With reference to FIG. 4, the interaction of time sectors A-D are shown as a continuum of sectors with different time durations and extremely different functionalities. In detail, time-sector A is where a machine 10 generates an electricity output Uₒ. Note: A includes both a free-fall time needed for the shuttle 40 to accelerate to its engagement velocity vₑ, and the time duration of shuttle 40 engagement with the linear generator 24. Time-sector B is where a shuttle 40 transits the transfer tank 20. Time-sector C is where the shuttle 40 is returned to the elevated start point 28 for its next cycle. And, time-sector D is diminished by a factor A for reset, as needed. Collectively, as mathematical expressions:

$$A + B + C + D = XA \qquad ( Eqn . \#1 )$$

$$C = nA And ; \qquad ( Eqn . \#2 )$$

$$D = A - Δ . \qquad ( Eqn . \#3 )$$

In Eqn #1, X is the total number of shuttles 40 being used in the machine 10.
In Eqn #2, n is the number of shuttles 40 rising in the water tower 22.
In Eqn #3, A is the reset time required to maintain Eqn #1.

While the system and methods for generating electricity with tandem towers as herein shown and disclosed in detail is fully capable of obtaining the objects and providing the advantages herein before stated, it is to be understood that it is merely illustrative of the presently preferred embodiment of the invention and that no limitations are intended to the details of construction or design herein shown other than as described in the appended claims.

What is claimed is:

1. A tandem tower machine for generating electricity which comprises:
a first electricity generator and a second electricity generator, wherein each electricity generator includes a water tower to establish a water pathway, and a linear generator which is juxtaposed with the water tower to establish an air pathway therebetween, wherein the water pathway and the air pathway are vertically oriented and parallel to each other in respective electricity generators, and further wherein each electricity generator includes an exclusively dedicated water compartment in a common water transfer tank for a controlled fluid communication between the water tower and the dedicated water compartment via a transfer valve to extend the water pathway from the water tower and into the transfer tank;
a first access valve of the first electricity generator positioned on the transfer tank to provide controlled access from the air pathway of the first electricity generator into its dedicated water compartment;
a second access valve of the second electricity generator positioned on the transfer tank to provide controlled access from the air pathway of the second electricity generator into its dedicated water compartment;
a control unit connected to the combination of access/transfer valves in each electricity generator, to alternatingly change the configuration of each access/transfer valve combination during a machine work cycle between an open/closed configuration and a closed/open configuration;
at least one shuttle for each electricity generator; and
a scheduling means connected with the control unit for establishing the open/closed or closed/open configurations of the access/transfer valve in the respective electricity generators opposite to each other, to alternately coordinate shuttle engagements with the respective linear generator for sequentially generating a combined electricity output from the machine.

2. The machine of claim 1 wherein the linear generator is an electrical conductor and a permanent magnet is mounted on the shuttle.

3. The machine of claim 1 wherein each electricity generator further comprises an upper pivot point mechanism positioned on the air pathway at an elevated start point for a shuttle, wherein the upper pivot point mechanism comprises:
a platform positioned at the elevated start point for receiving the shuttle after the shuttle breaches from the water tower; and
an activator for rotating the platform around an axis to drop the shuttle onto the air pathway for engagement with the linear generator at a constant velocity, to generate the electricity output for the machine.

4. The machine of claim 3 further having a lower pivot point structure which comprises a submerged guideway fixed in the transfer tank to receive the shuttle from the air pathway for transit on the water pathway through the transfer tank and up the water tower for a shuttle return to the elevated start point.

5. The machine of claim 4 wherein the scheduling means includes a protocol defining a time sector A which is based on a distance beginning at the elevated start point of the shuttle and continuing along the linear generator to the access valve of the transfer tank below the linear generator.

6. The machine of claim 5 wherein the scheduling means further defines a time sector B based on a distance between the access valve of the transfer tank and a predetermined point in the water tower above the transfer valve of the transfer tank.

7. The machine of claim 6 wherein the scheduling means further defines a time sector C based on a distance between the predetermined point ending time sector B and the water level at the top of the water tower where the shuttle breaches from the water tower.

8. The machine of claim 7 wherein the scheduling means further defines a time sector D based on the time between shuttle breach at the end of time sector C and the shuttle drop at the beginning of time sector A.

9. The machine of claim 8 wherein the time sector B is greater than time sector A, wherein the time sector C is greater than time sector B, wherein time sector D is less than time sector A. and wherein the sum of time sectors B+C+D is a multiple of the time sector A.

10. The machine of claim 9 wherein the time sector D compensates for deviations of time sector B and C from the time sector A.

11. A method for constructing an electricity generator of a tandem tower machine, wherein the electricity generator establishes a closed loop pathway and the method comprises the steps of:
building an air pathway component for the closed loop pathway having a platform for receiving a shuttle at an elevated start point onto the air pathway, and a linear generator positioned below the platform to engage with the shuttle after the shuttle is dropped from the elevated start point for engagement with the linear generator;
creating a water pathway component connected with the air pathway component to complete the closed loop pathway for a return of the shuttle to the elevated start point after shuttle disengagement from the linear generator, wherein the water pathway component sequentially includes a transfer tank and a water tower with a transfer valve located therebetween to control fluid communication between the transfer tank and the water tower; and
apportioning the closed loop pathway into time sectors with a time sector A based on a distance beginning at the elevated start point and continuing along the linear generator to an access valve on the transfer tank located below the linear generator, a time sector B based on a distance between the access valve of the transfer tank and a predetermined point in the water tower above the transfer valve, a time sector C based on a distance between the predetermined point in the water tower ending time sector B and the water level at the top of the water tower where the shuttle breaches from the water tower; and a time sector D based on a controlled time between shuttle breach at the end of time sector C and the shuttle drop at the beginning of time sector A.

12. The method of claim 11 wherein the time sector B is greater than time sector A, wherein the time sector C is greater the than time sector B, where the time sector D is less than time sector A and wherein the sum of time sectors B+C+D is a multiple of the time sector A.

13. The method of claim 12 wherein the time between time sector D compensates for deviations of time sector B and C from the time sector A.

14. The method of claim 13 comprising the steps of:
constructing a second electricity generator, wherein the second electricity generator has the same structure and cooperation of structure as the first electricity generator; and
bifurcating the transfer tank into a first water compartment and a second water compartment, wherein the first electricity generator is operatively engaged with the first water compartment and the second electricity generator is similarly engaged with the second water compartment.

15. The method of claim 14 wherein the bifurcating step establishes a combination of access/transfer valves for the water compartment of the first electricity generator and a similar combination of access/transfer valves for the water compartment of the second electricity generator.

16. The method of claim 15 further comprising the step of connecting the combination of access/transfer valves of the first electricity generator and the combination of access/transfer valves of the second electricity generator to a control unit.

17. The method of claim 16 further comprising the step of positioning a reciprocating piston plate in a water channel between the first and second water compartments of the transfer tank, wherein the piston plate is connected to the control unit to coordinate piston movements with the operations of the access/transfer valve combinations in the respective water compartments.

18. The method of claim 17 wherein as the piston plate moves in an advancing direction the combination of access/transfer valves have an opened/closed configuration in the first water compartment, and when the piston moves in the reciprocal direction the access/transfer valves in the first water compartment have a closed/opened configuration.

19. The method of claim 17 wherein as the piston plate moves in an advancing direction the combination of access/transfer valves have a closed/open configuration in the second water compartment, and when the piston moves in the reciprocal direction the access/transfer valves in the first water compartment have a opened/closed configuration.

20. The method of claim 17 further comprising a means for moving the piston plate, wherein the moving means is connected to the control unit for coordinating access/transfer valve operations during a machine duty cycle.
